(19) United States
(12) Patent Application Publication
(10) Pub. No.: US 2013/0229653 A1
(43) Pub. Date: Sep. 5, 2013

(54) SPECTROMETRIC OPTICAL SYSTEM AND SPECTROMETER

(71) Applicant: SONY CORPORATION, Tokyo (JP)

(72) Inventors: Hirokazu Tatsuta, Tokyo (JP); Eiichi Tanaka, Chiba (JP); Suguru Dowaki, Kanagawa (JP)

(73) Assignee: Sony Corporation, Tokyo (JP)

(21) Appl. No.: 13/772,003

(22) Filed: Feb. 20, 2013

(30) Foreign Application Priority Data
Mar. 2, 2012 (JP) 2012-047370

(51) Int. Cl. G01J 3/18; G02B 5/18

(52) U.S. Cl. CPC G01J 3/18; G02B 5/1814
USPC 356/328; 359/570

(57) ABSTRACT

There is provided a spectrometric optical system, comprising a reflection member having a concave surface formed along a first circle, a diffraction grating having an edge part and a convex surface formed along a second circle disposed concentrically with the first circle, on which the light reflected at the concave surface of the reflection member is incident, and an input element disposed at a predetermined position to the reflection member and the diffraction grating such that a diffracted light, emitted from the diffraction grating, having a wavelength region of not less than 600 nm to not more than 1100 nm, and reflected at the concave surface, passes between the input light input to the spectrometric optical system and the edge part of the diffraction grating.

### BACKGROUND

The present technology relates to a spectrometric optical system utilizing a laser beam and a spectrometer using the same.

As a spectrometer with high imaging properties, an Offner type spectrometer is known. For example, the Offner type spectrometer is disclosed in Japanese Patent Application Laid-open No. 2010-181413. (For example, see the paragraph [0009] in Japanese Patent Application Laid-open No. 2010-181413).

In general, the Offner type spectrometer includes two mirrors concentrically disposed (a primary mirror and a secondary mirror), and is a relay optical system having a magnification factor of 1. Such a relay optical system has the properties such as very little optical aberration and distortion.

The Offner type spectrometer includes the afore-mentioned relay optical system and a diffraction grating having a convex surface disposed above a convex surface of the secondary mirror.

The Offner type spectrometer described in Japanese Patent Application Laid-open No. 2010-181413 includes a slit (20) for passing a laser beam, a concave mirror (35) that reflects the beam from the slit, and a convex diffraction grating (60), concentrically disposed to the concave mirror, having radius of curvature smaller than that of the concave mirror. A sensor (50) detects the light provided by the Offner type spectrometer. The slit and the sensor is for imaging, an axis on a detection surface of the sensor in one direction corresponds to any one axis in a space, and other axis vertical to the one axis corresponds to a wavelength axis (scattered wavelength, i.e., spectral domain). The spectrometer having such an optical system is called as an imaging spectrometer, and can inhibit distortion of slit images.

The Offner type spectrometer thus configured provides pronounced imaging properties such as little optical aberration and inhibited distortion of the slit images.

The Offner type spectrometer is also disclosed in Japanese Patent Application Laid-open No. 2008-510964.

### SUMMARY

In the Offner type spectrometric optical system, an effort is necessary for detecting a light having a specific wavelength range.

It is desirable to provide a spectrometric optical system for detecting a light having a specific wavelength range and a spectrometer using the same.

The spectrometric optical system according to an embodiment of the present technology includes a reflection member, a diffraction grating, and an input element.

The reflection member has a concave surface formed along a first circle having a center.

The diffraction grating has an edge part and a convex surface formed along a second circle disposed concentrically with the first circle, on which the light reflected at the concave surface of the reflection member is incident.

The input element is disposed at a predetermined position to the reflection member and the diffraction grating such that a diffracted light passes between the input light input to the spectrometric optical system and the edge part of the diffraction grating. The diffracted light has a wavelength region of not less than 600 nm to not more than 1100 nm, and is reflected at the concave surface.

According to an embodiment of the present technology, the diffracted light passing between the input light and the edge part of the diffraction grating, reflected on the concave surface and having a wavelength region of not less than 600 nm to not more than 1100 nm can be detected.

The diffraction grating may have a principal point that is intersected with a first axis perpendicular to a center axis that is a common axis of the first circle and the second circle. In other words, a light axis of the light reflected on the concave surface (a reflected light of the input light) is intersected at the principal point of the diffraction grating.

The diffraction grating may emit the diffracted light at an emission angle smaller than an incident angle of the light reflected on the concave surface to the diffraction grating.

Each radius of curvature on the convex surface of the reflection member and the concave surface of the diffraction grating is set, such that the radius of curvature on the second circle is R and the radius of curvature on the first circle is substantially (R/2)±5%). That is, the spectrometric optical system utilizes the Offner type spectrometric optical system.

A distance between the first axis and the second axis that is in parallel with the first axis and coincides with the light axis of the input light incident on the concave surface may be R/5 to R/4.

The input element may have a slit element having a slit for passing the input light.

The input element may have at least one of a first mirror for reflecting the input light emitted from the slit element and leading it to the concave surface, and a second mirror for reflecting the diffracted light reflected on the concave surface and leading it to the sensor, whereby mechanical interference by the arrangement of the input element and the sensor can be avoided.

The input element may have a prism mirror including the first mirror and the second mirror. The prism mirror is disposed between the slit element and the sensor, which are disposed linearly to reduce the space where the slit element, the prism and the sensor are disposed. Thus, the sensor can be freely disposed. For example, the prism may be disposed as follows:

The slit element and the prism may be disposed such that an incident angle of the input light to the first mirror is 45 degrees and an incident angle of the diffracted light to the second mirror is 45 degrees.

The slit element may have an NA (Numerical Aperture) of 0.03 or more to 0.1 or less.

The spectrometric optical system may further include a band pass filter, which is disposed before the input element, for passing the input light having the wavelength region of 600 nm to 1100 nm. Such a configuration can avoid the generation of a stray light.

A spectrometer according to an embodiment of the present technology includes a laser light source, an integrator element, an oscillating element, a light collecting element, the spectrometric optical system, and an optical system.

The oscillating element can guide the laser beam emitted from the laser light source to the integrator element, and oscillates to change an incident angle of the laser beam to the integrator element.

The light collecting element collects the laser beam emitted from the oscillating element.

The optical system maintains an optical conjugation between a collecting surface of the laser beam emitted from the collecting element and an input surface of the laser beam incident on the input element.

According to the embodiment of the present technology, there can be provided a spectrometric optical system and a spectrometer for detecting a light having a specific wavelength range.

These and other objects, features and advantages of the present technology will become more apparent in light of the following detailed description of best mode embodiments thereof, as illustrated in the accompanying drawings.

### BRIEF DESCRIPTION OF DRAWINGS

FIGS. 1A and 1B each shows an illumination optical system according to a reference embodiment;

FIG. 2 shows an illumination optical system according to a first embodiment of the present technology viewing a short axis direction of a laser diode as a direction perpendicular to a paper surface;

FIG. 3 shows a deflection angle range of a laser beam by an oscillating element;

FIG. 4 shows an illumination optical system according to a second embodiment of the present technology;

FIGS. 5A to 5C each shows an illumination optical system according to a third embodiment of the present technology, the views being different from each other at 90 degrees;

FIG. 6 shows an illumination optical system according to a fourth embodiment of the present technology;

FIGS. 7A to 7C each shows an intensity distribution of a beam line formed on a screen captured by an image sensor;

FIG. 8 is a graph plotting an intensity of a laser beam generated by an illumination optical system each corresponding to FIGS. 7B and 7C, an abscissa axis scale representing a long axis of the beam and a longitudinal axis scale representing the intensity of the beam;

FIG. 9A shows an edge blur (bokeh) of the illuminated light provided by the illumination optical system according to the second embodiment;

FIG. 9B shows an edge blur of the illuminated light provided when a focal length of an integrator lens is close to that of a collecting lens in the illumination optical system according to the fourth embodiment;

FIG. 10A shows a principle of an Offner type same magnification optical system (a relay optical system);

FIG. 10B shows a principle of an Offner type spectrometer utilizing the Offner type optical system;

FIG. 11 shows a spectrometric optical system according to the first embodiment of the present technology;

FIG. 12A is an incident surface of a diffraction grating;

FIGS. 12B to 12D each shows an enlarged view of a square enclosed by a dashed line shown in FIG. 12A;

FIG. 13 shows a spectrometric optical system according to the second embodiment of the present technology;

FIG. 14 shows an example of the spectrometric optical system according to the second embodiment;

FIG. 15 shows a data of observing illumination of an Ar lamp in the spectrometric optical system of the embodiment;

FIG. 16 shows an observed example of a line and space at a 10 μm pitch by connecting the spectrometric optical system to a microscopic optical system according to the embodiment;

FIG. 17 is a graph of a spectrum of an AR lamp measured by using the spectrometric optical system according to the embodiment;

FIG. 18 is an enlarged view of FIG. 17 at a wavelength of around 800 nm;

FIG. 19 shows a calculation example of a diffraction efficiency of the diffraction grating shown in FIG. 12C using an RCWA (Rigorous Coupled Wave Analysis) method; and

FIG. 20 shows a configuration of an optical system in a Raman imaging apparatus (Raman spectrometry apparatus).

### DETAILED DESCRIPTION OF EMBODIMENTS

Hereinafter, an embodiment of the present technology will be described with reference to the drawings.

### Illumination Optical System

### Reference Embodiment

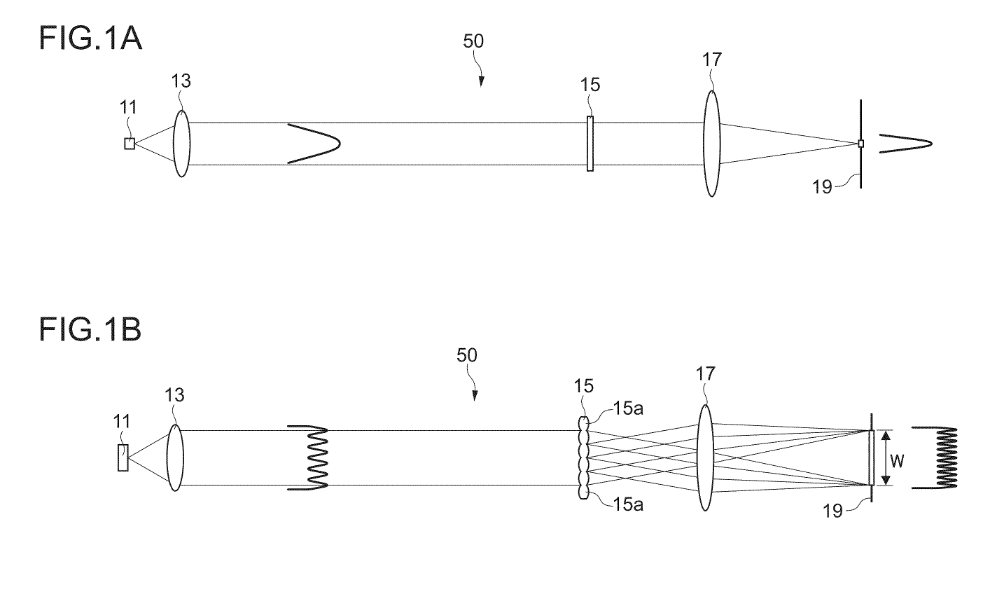

FIGS. 1A and 1B each shows an illumination optical system according to a reference embodiment. The illumination optical systems shown in FIG. 1A and FIG. 1B are different at 90 degrees each other.

The illumination optical system 50 according to the reference embodiment includes a laser diode 11, a collimator lens 13, an integrator lens 15 and a collecting lens 17.

In many laser diodes 11, if coherency is ignored, a luminous point (an emitter) has an almost rectangular shape. In the reference embodiment shown in FIGS. 1A and 1B, different optical systems are used in a rectangular short axis (fast axis) laser beam and in a long axis (slow axis) laser beam that is at an right angle thereto. The different optical systems are used because one optical system, i.e., the second optical system corresponding to the long axis optical system, employs a Kehler illumination optical system in order to irradiate a screen (or a sample surface) with a uniform and straight light having an intended aspect ratio.

Hereinafter, the optical system shown in FIG. 1A is referred to as a first optical system, and that shown in FIG. 1B is referred to as a second optical system as a matter of convenience.

The laser beam emitted from the laser diode 11 is changed to a parallel light by a collimator lens 13. An intensity profile of the laser beam emitted from the collimator lens 13 has a Gaussian distribution (TEM00) in the short axis direction. On the other hand, an intensity profile of the laser beam in the long axis direction has non-uniform distribution (TEM05).

A difference between the first and second optical systems is a shape of an integrator lens 15. As the integrator lens 15, a lenticular lens, where a plurality of cylindrical lenses 15a (a lens array) is arranged and configured in the long axis of the laser beam, is used. That is to say, the integrator lens 15 has power in the long axis direction to the laser beam and has no power in the short axis direction.

As shown in FIG. 1B, the laser beam of the parallel light is split by the integrator lens 15 and is superposed by the collecting lens 17. Thus, the intensity of the light irradiated on the screen 19 can be uniform in the long axis direction.

The integrator lens 15 has no power in the short axis direction of the laser diode 11. The sample surface is directly irradiated with the beam having the intensity profile with the Gaussian distribution. The first optical system becomes a critical illumination optical system.

An illumination width (irradiation range of a beam) W on the screen 19 can be determined by the following numerical expression 1:

$$W = p \cdot \frac{{f}_{cond}}{{f}_{integ}} \qquad Numerical expression 1$$

where p represents a pitch of each cylindrical lens 15a of the integrator, f_{cond} represents a focal length of the collecting lens 17 and f_{integ} represents a focal length of the integrator lens 15.

Numerical expression 1 shows that the lenses are arranged so that a position at a collecting light point of the integrator lens 15 is matched with a position at the focal length f_{cond} of the collecting lens 17.

As described above, even if the Kehler illumination optical system is used as the second optical system, the interference fringes attributed to the integrator lens 15 may be produced, and speckles may be produced by a small fluctuation on a wave surface.

### Illumination Optical System According to First Embodiment

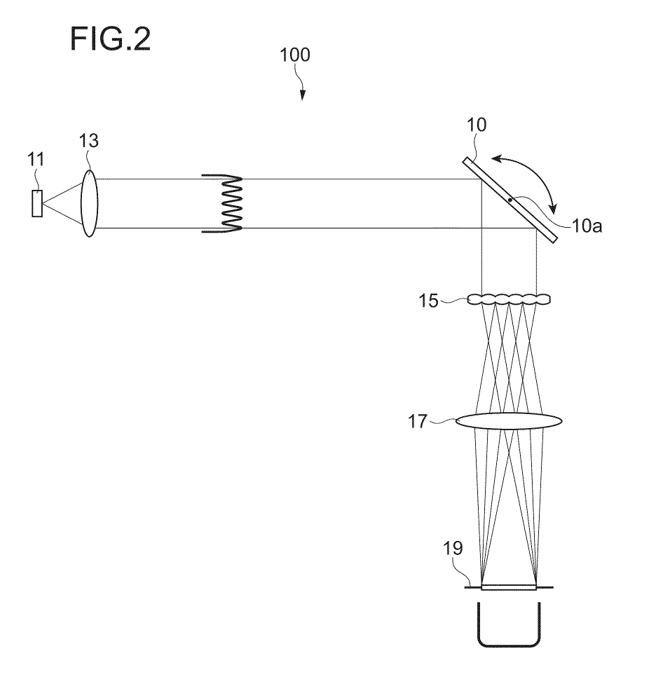

FIG. 2 shows an illumination optical system according to a first embodiment of the present technology viewing a short axis direction of a laser diode 11 as a direction perpendicular to a paper surface.

The illumination optical system 100 includes a laser diode 11 as a laser light source, a collimator lens 13, an oscillating element 10, an integrator lens 15 as an integrator element and a collecting lens 17 as a collecting element.

The integrator lens 15 is a lenticular lens that has power in the long axis direction of the laser diode 11 to the laser beam and has no power in the short axis direction similar to that shown in FIGS. 1A and 1B. Accordingly, the shape of the laser beam on a screen 19 (or a sample surface) in the short axis direction is substantially the same as that shown in FIG. 1A, and the optical system at the short axis side is not shown.

Both of the incident and emitted surfaces of the integrator lens 15 have convex shapes.

Similar to the above-described reference embodiment, the optical system of the integrator lens 15 having no power in the short axis direction becomes a critical illumination optical system. An illumination width in the short axis direction on the screen 19 is obtained by multiplying a ratio of respective focal lengths of the collimator lens 13 and the collecting lens 17 by a length of the emitter in the short axis direction.

The oscillating element 10 can reflect the laser beam at the collimator lens 13, guide the laser beam to the integrator lens 15, and oscillate to change an incident angle of the laser beam to the integrator lens 15.

As the oscillating element 10, a resonant mirror is typically used. The resonant mirror is configured to rotate around an axis of rotation 10a in the short axis direction at a predetermined angle, and then rotate in the reverse direction at a predetermined angle. In other words, the resonant mirror thus oscillates. The resonant mirror typically has a mirror, a permanent magnet and a coil wiring, and oscillates by electromagnetic actuation. For example, an alternating current flows through a coil disposed around a mirror surface in a magnetic field produced by the permanent magnet, thereby oscillating the mirror.

An oscillation frequency of the oscillating element 10 can be set as appropriate by the apparatus to which the illumination optical system 100 is applied. For example, when a person sees (or observes) with naked eyes an object illuminated by the illumination optical system 100, the oscillation frequency is such that the oscillation may not be perceived by the person. Alternatively, when an object illuminated by the illumination optical system 100 is detected by the image sensor, the oscillation frequency is sufficiently shorter than an exposure time by the image sensor.

When the resonant mirror is used, the oscillation provides a sine curve. Accordingly, the oscillation mirror is operated at an oscillation center at highest speed. The speed becomes zero at the highest deflection angle. When the integrator lens 15 is not disposed and the oscillation mirror is used, a power density becomes high at both ends of the laser beam, the center gets dark, and the intensity non-uniformity tends to be produced. However, by using the integrator lens 15, the production of the intensity non-uniformity by the oscillation can be inhibited. Thus, the intensity uniformity can be provided.

Then, the incident angle θ of the laser beam incident on the integrator lens 15 will be described.

The incident angle θ of the laser beam incident on the integrator lens is typically defined by the following numerical expression 2.

$${tan}^{- 1} ( \frac{λ \cdot {f}_{cond}}{p \cdot {f}_{integ}} ) < θ < {tan}^{- 1} ( \frac{p ( n - 1 )}{2 r} ) ≅ {tan}^{- 1} ( \frac{p}{2 {f}_{integ}} ) \qquad Numerical expression 2$$

where n represents a refractive index, r represents radius of curvature, and λ represents a wavelength of the laser beam.

Thus, the positions of the interference fringes produced on the screen 19 are changed by adjusting a beam angle. Accordingly, the illumination irradiated on the screen 19 can be considered as uniform illumination on time average.

The upper limit of the incident angle θ will be expressed by the following numerical expression 3 of which is a part of the numerical expression 2.

$$θ < {tan}^{- 1} ( \frac{p ( n - 1 )}{2 r} ) ≅ {tan}^{- 1} ( \frac{p}{2 {f}_{integ}} ) \qquad Numerical expression 3$$

The range of the incident angle θ expressed by the numerical expression 3 shows the conditions that the beam (here it may be easily understand that the beam is considered as the edge of the beam) is incident and emitted on/from the single cylindrical lens 15a of the integrator lens 15. In other words, the oscillating element 10 oscillates so that the oscillation width of the laser beam incident on the integrator lens 15 is not greater than the width of the single cylindrical lens 15a.

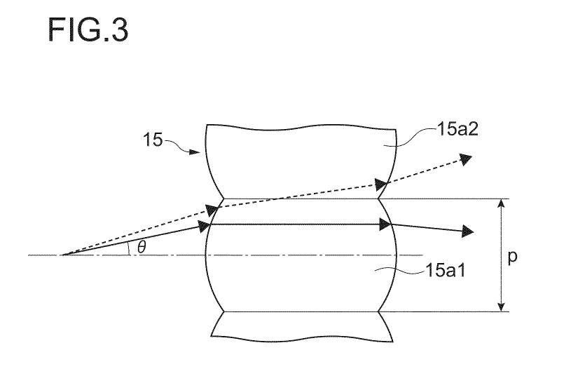

FIG. 3 shows a deflection angle (here the incident angle θ) range of the laser beam by the oscillating element 10. In FIG. 3, the beam shown by the dashed line is incident on a first cylindrical lens 15a1 and emitted from a neighbor second cylindrical lens 15a2. The dashed line beam is deviated from the numerical expression 1 (W=p×f_{cond}/f_{integ}) as described above. As a result, no adequate aspect ratio is provided.

According to the conditions of the numerical expression 3, an edge rise of the illuminated light in the long axis direction becomes the best to sharpen the illumination range on the screen 19. In contrast, when the incident angle θ of the beam becomes too large, the edge of the illuminated light in the long axis direction blurs. The smaller the ratio (f_{cond}/f_{integ}) of the focal length f_{cond} of the collecting lens 17 and the focal length f_{integ} of the integrator lens 15 is, the more the accuracy of the edge rise becomes severe.

The lower limit of the incident angle will be expressed by the following numerical expression 4 of which is a part of the numerical expression 2.

$$θ > {tan}^{- 1} ( \frac{λ \cdot {f}_{cond}}{p \cdot {f}_{integ}} ) \qquad Numerical expression 4$$

It is desirable to satisfy the numerical expression 4 in order to oscillate the laser beam at or exceeding the pitch of the interference fringes caused by the integrator lens 15 and produced on the screen 19. The integrator lens 15 and the collecting lens 17 are disposed at the positions corresponding to the respective focal lengths f_{integ} and f_{cond}. As a result, a travel distance of the beam over the screen 19 is determined by the focal length f_{integ} of the integrator lens 15. The travel distance “a” equals to f_{integ} tan θ. The pitch of the interference fringes equals to λ×f_{cond}/p. In other words, f_{integ} tan θ>λ×f_{cond}/p is desirable to provide the numerical expression 4.

As described above, in the illumination optical system 100 according to the present embodiment, as the oscillating element 10 oscillates to change the incident angle of the laser beam to the integrator lens 15, uniform light can be emitted from the light collecting lens 17 on time average. A production of the interference fringes or speckles caused by the integrator lens 15 can be inhibited and desirable homogenization effects can be provided.

By defining the deflection angle (incident angle θ) of the oscillating element 10 as described above, a production of the interference fringes and the speckles can be inhibited with certainty.

In the apparatus described in Japanese Patent Application Laid-open No. 8-111368, a fly eye lens that is an element being a relatively large in mass is mechanically vibrated. Therefore, there are problems that the reliability is poor and the apparatus may be impossible to stand the long-term use. In contrast, the technology according to the present technology can solve the problems.

### Illumination Optical System According to Second Embodiment

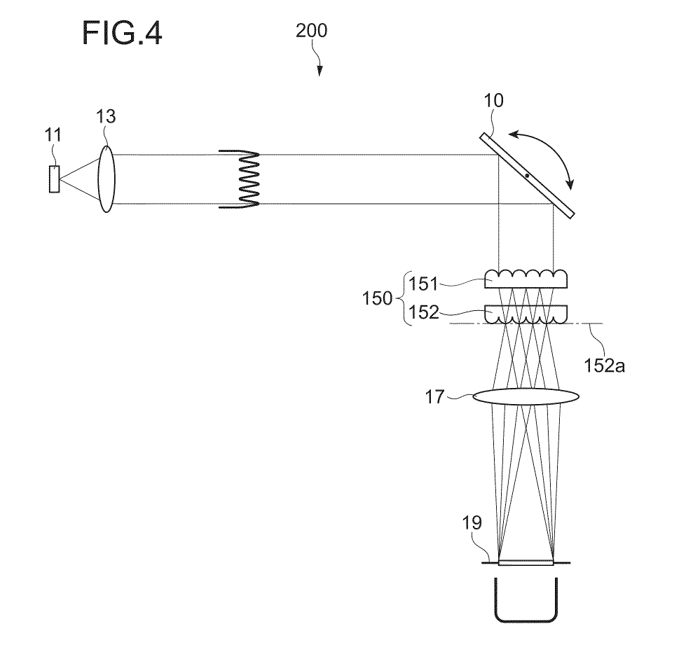

FIG. 4 shows an illumination optical system according to a second embodiment of the present technology. Hereinafter, the members, the functions and the like similar to those of the illumination optical system 10 according to the embodiment shown in FIG. 2 and the like are simplified or omitted, and different points will be mainly described until a fourth embodiment of the present technology.

The illumination optical system 200 includes an integrator element 150 including a plurality of integrator lenses 15. The laser beam reflected at the oscillating element 10 is incident on a first integrator lens 151 (a first integrator element). The laser beam split by the first integrator lens 151 is incident on a second integrator lens 152 (a second integrator element).

Similar to the first embodiment, the integrator lens 151 has a plurality of cylindrical lenses each having power in the long axis direction to the laser beam. The second integrator lens 152 has the configuration similar to that of the first integrator lens 151, and has the same number of the cylindrical lenses disposed corresponding to the respective cylindrical lenses of the first integrator lens 151 in the light axis direction. In other words, both the lens pitches in the cylindrical lenses of the integrator lenses 151 and 152 are substantially the same. This allows the laser beam split by the respective cylindrical lenses of the first integrator lens 151 to be incident on the cylindrical lenses of the second integrator lens 152 in the light axis direction corresponding to the cylindrical lenses.

The emitted surface of the first integrator lens 151 and the incident surface of the second integrator lens 152 are formed in a plane.

The curvature, i.e., power of each of the cylindrical lens of the two integrator lenses 151 and 152 is desirably substantially the same. It is also desirable that the first and the second integrator lenses be disposed so that a focal position of the first integrator lens 151 is positioned on a main plane 152a of the second integrator lens 152. The main plane 152a formed by apexes of the respective convex surfaces of the second integrator lens 152.

The second integrator lens 152 thus configured acts as a field lens.

For example, when one integrator lens 15 is used as in the first embodiment, the edge of the irradiated light on the screen 19 may have poor sharpness depending on the conditions (when the focal length of the integrator lens 15 approaches the length of the collecting lens 17). In contrast, according to the embodiment of the present technology, the light fallen outward by the first integrator lens 151 is returned back inward by the second integrator lens 152. This allows the superposition of the collecting lens 17 to be improved and the edge of the irradiated light to be sharpened.

When it assumes that the focal length of the integrator lens 15 is relatively closer to the focal length of the collecting lens 17, the collecting lens 17 has the focal length 10 to 20 times longer than that of the integrator lens 15.

### Illumination Optical System According to Third Embodiment

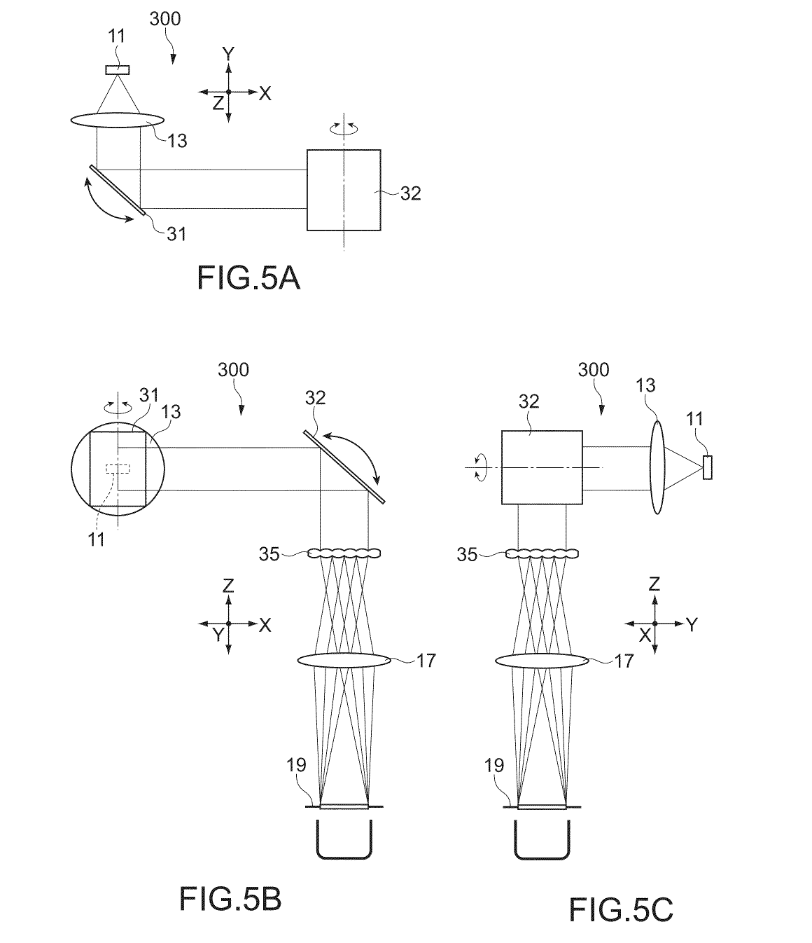

FIGS. 5A to 5C each shows an illumination optical system according to a third embodiment of the present technology, the views being different from each other at 90 degrees.

The illumination optical system 300 according to the third embodiment includes a first oscillating element 31 and a second oscillating element 32 as two oscillating elements. Similar to the first and second embodiments, as these oscillating elements 31 and 32, a resonant mirror is used. The first oscillating element 31 oscillates about the axis of rotation as a short axis (Z axis) of the laser beam. The second oscillating element 10 oscillates about the axis of rotation as a long axis (Y axis) of the laser beam.

The laser beam emitted from the collimator lens 13 along the Y axis direction is reflected by the first oscillating element 31 while oscillating in the long axis direction, and travels to the X axis direction. The laser beam reflected by the first oscillating element 31 is reflected by the second oscillating element 32 while oscillating in the sort axis direction, and travels to the Z axis direction.

As shown in FIGS. 5B and 5C, as the integrator lens (integrator element), a fly eye lens 35 having power in the both short and long directions is used. Specifically, the fly eye lens 35 includes a lens array where convex lenses are arranged in a matrix.

Also, in the third embodiment, the numerical expression 1 holds in both the short and long axes, and the numerical expression 2 holds in both the short and long axes as well.

According to the third embodiment, a production of the interference fringes and the speckles on both the long and short axes can be inhibited, and the light can be uniformly irradiated on the screen 19 in the both directions.

### Illumination Optical System According to Fourth Embodiment

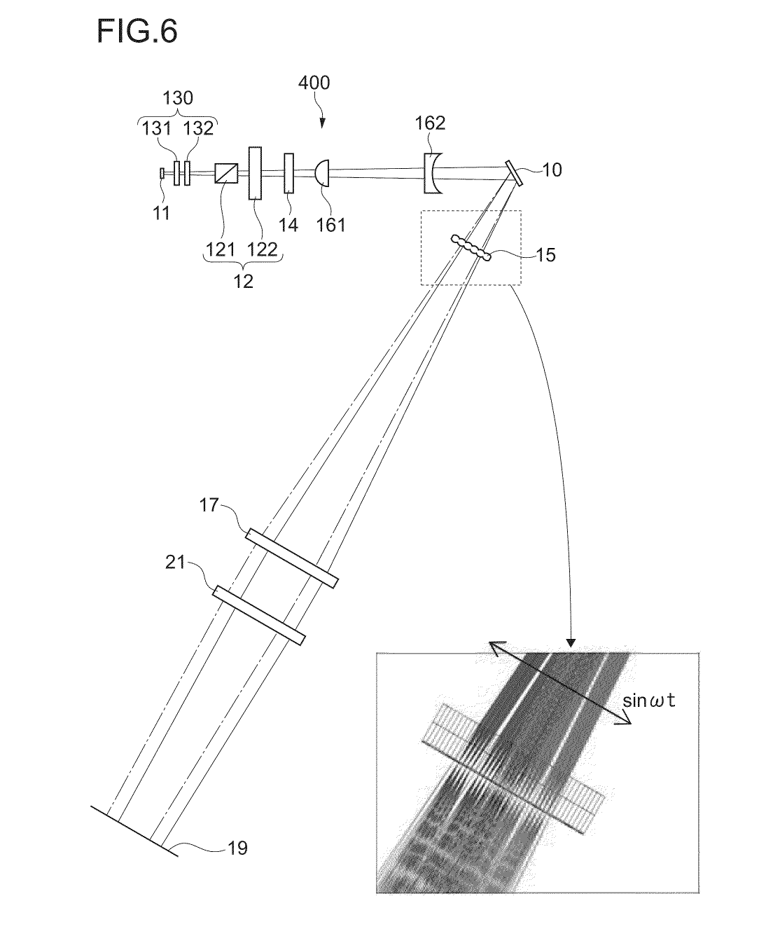

FIG. 6 shows an illumination optical system according to a fourth embodiment of the present technology.

In the illumination optical system 400, the illumination optical system 100 according to the first embodiment is applied to an illumination optical system of a Raman imaging apparatus (Raman spectrometry apparatus). The Raman scattered light is produced when a sample is irradiated with the laser beam to shift a wavelength of the molecules constituting the sample for vibrating molecules. The Raman imaging apparatus two-dimensionally detects a spectrum of the scattered light.

The Raman imaging apparatus uniformly and linearly illuminates the sample using the illumination optical system 400. In the case of a Stokes Raman scattering detection, a specific wavelength area of the Raman scattered light excited by the illumination is limited by a highpass filter to guide the light to the spectrometer (spectrometric optical system) as described later.

The illumination optical system 400 includes a laser diode 11, a collimator lens group 130, an isolator 12, an ND filter 14, a convex surface cylindrical lens 161, a concave cylindrical lens 162, an oscillating element 10, an integrator lens 15, a collecting lens 17 and a laser Raman filter 21.

A line width of the laser for exciting Raman scattering affects on a line width of scattered light. Accordingly, a monochrome laser having a half-value width of about 0.1 nm is necessary. Such a laser also has a high coherency. Typically, a laser diode having a wavelength of 785 nm is used as the laser light source.

An emitter of the laser has a short axis of 1 μm and a long axis of 100 μm. A multi-mode laser diode is used. In order to improve monochrome and temperature properties, a diffraction grating may be disposed as an external resonator for selecting a wavelength after collimating by the collimator lens group 130. An FFP (Far Field Pattern) of the laser light source has a non-uniform beam profile (TEM05).

The light source of the laser diode 11 is configured to have 14000 μm×80 μm with a uniform and high aspect ratio. In this case, the aspect ratio roughly equals to a slit width of the area detected by the Raman spectrometer.

The collimator lens group 130 has a collimator lens for a short axis 131 and a collimator lens for a long axis 132, for example.

The isolator 12 has a polarization beam splitter 121 and a λ/4 plate 122. The isolator 12 transmits the laser beam from the collimator lens group 130. The polarization beam splitter 121 reflects the laser beam reflected by each element at a later stage after the λ/4 plate 122 so as not to return the laser beam to the laser light source.

The ND filter 14 adjusts a density (an amount of light) of the laser beam.

The convex surface cylindrical lens 161 and the concave cylindrical lens 162 magnify its beam diameter 4.8 times of the parallel light.

Similar to the first and second embodiments, as the oscillating element 10, a resonant mirror is used. The axis of rotation of the resonant mirror is disposed along a short axis direction.

As shown in the first and second embodiments, the integrator lens 15 has a lens array of a plurality of cylindrical lenses arranged in the long axis direction. The illumination optical system 400 is a critical illumination at the short axis side. Homogenization is unnecessary. The integrator lens 15 acts as a simple reflecting surface in the short axis direction.

FIG. 6 shows a magnified oscillating laser beam passing through the integrator lens 15.

The ratio (f_{cond}/f_{integ}) of the focal length f_{cond} of the collecting lens 17 and the focal length f_{integ} of the integrator lens 15 is 56. The travel distance of the irradiated light on the screen 19 (or a sample surface) can be short to the deflection angle of the laser beam by the resonant mirror. The interference fringes in the laser beam produced by the integrator lens 15 have a pitch of about 300 μm. The deflection angle of the resonant mirror is about 1.5 degrees, so that an oscillating quantity of the illuminated light is twice, i.e., about 600 μm. The deflection angle satisfies the above-described numerical expression 2.

The oscillation frequency of the resonant mirror is sufficiently shorter than the exposure time by the image sensor in the spectrometer as described later, and may be about 1/10 of the exposure time by the image sensor, for example. Typically, the frequency is a resonance frequency of about 560 Hz.

The laser line filter 21 cuts the bottom of the laser as well as a fluorescent light and a Raman scattered light produced within the lens.

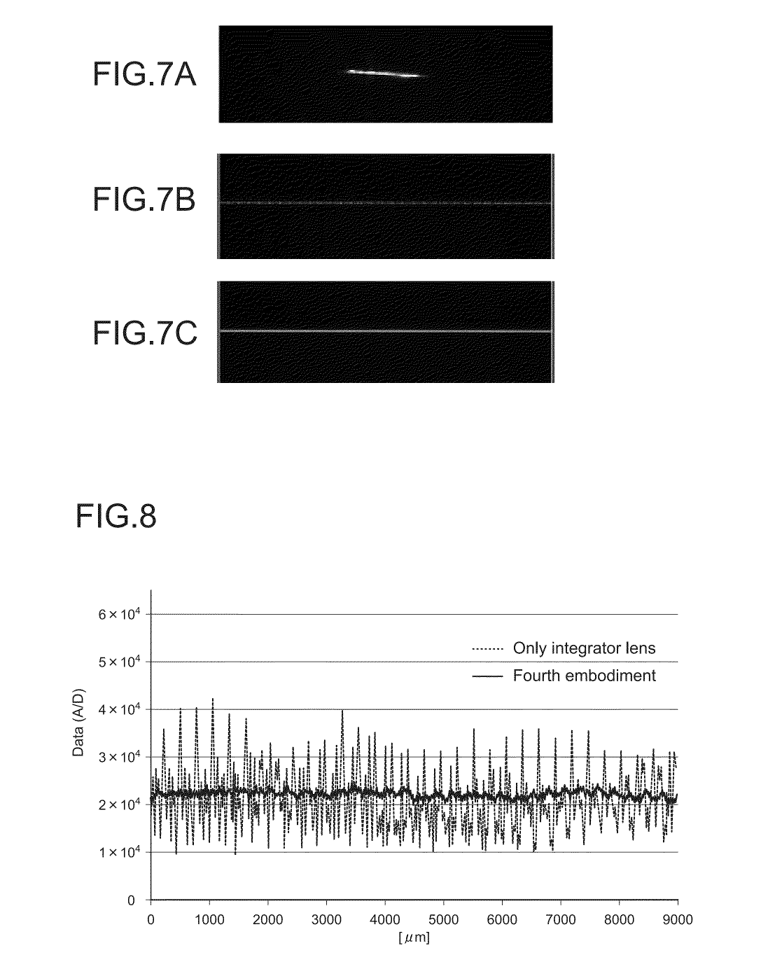

FIGS. 7A to 7C each shows an intensity distribution of a beam line formed on a screen 19 captured by an image sensor. An abscissa axis represents a long axis.

FIG. 7A shows the case that the integrator lens 15 is not used and the resonant mirror is not oscillated (used as a simple mirror). In this case, the intensity distribution of the beam has a TEM05 node. An emitter shape of the laser diode 11 is directly observed, which means the critical illumination.

FIG. 7B shows the case that the integrator lens 15 is used and the resonant mirror is not oscillated. In this case, although the Kehler illumination optical system is provided, the interference fringes caused by the integrator lens 15 are observed.

FIG. 7C shows a fourth embodiment of the present technology. The node shown in FIG. 7A and the interference fringes shown in FIG. 7B can be cancelled.

FIG. 8 is a graph plotting an intensity of a laser beam generated by an illumination optical system each corresponding to FIGS. 7B and 7C. An abscissa axis scale represents a long axis of the beam and a longitudinal axis represents the intensity of the beam. The intensity in the longitudinal axis is shown in a digital value. It can be confirmed that the uniformity of the intensity distribution of the illuminated light according to the fourth embodiment shown by a solid line, as compared with that in FIG. 7C.

Then, an edge blur of the irradiated light on the screen 19 will be described.

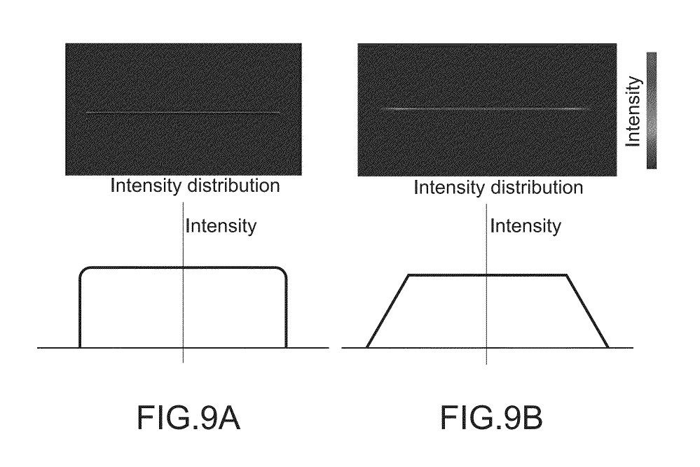

FIG. 9A shows an edge blur of the irradiated light provided by the illumination optical system 200 according to the second embodiment. An upper part in FIG. 9A shows the intensity distribution, and a lower part in FIG. 9A shows a profile of the intensity distribution. The experiment was performed on the apparatus where one integrator lens 15 in the illumination optical system 400 according to the fourth embodiment is replaced with dyad integrator elements 150 in the illumination optical system 200 according to the second embodiment.

On the other hand, FIG. 9B shows an edge blur of the illuminated light provided when the focal length of the integrator lens 15 is close to that of the collecting lens 17 in the illumination optical system 400 according to the fourth embodiment as described above. Such phenomenon occurs when the laser beam reflected by the resonant mirror is oblique incident on the integrator lens 15 (because the laser beam is oscillated). However, the dyad integrator elements 150 are used as in the second embodiment to inhibit the production of the edge blur, as shown in FIG. 9A.

It should be appreciated that no edge blur is produced when the illumination optical system 400 is used as long as the focal length of the integrator lens 15 and the focal length of the collecting lens 17 have a relatively long distance.

The upper views in FIGS. 9A and 9B each shows in a grayscale and are hard to be distinguished. The originals of these views have colors.

As described above, the illumination optical system according to the respective embodiments is applied to the light irradiation apparatus for spectrometry, thereby providing a uniform illuminated light, and obtaining images with high illuminance uniformity. The spectrometer is typically a Raman imaging apparatus, but may be other spectrometers.

The above-mentioned illumination optical system according to the respective embodiments can be applied to a projector or the like as well as the spectrometer. Alternatively, the above-mentioned illumination optical system according to the respective embodiments can be applied to a processing apparatus including an exposure apparatus, an annealing apparatus and the like. When the illumination optical system is applied to the processing apparatus, a surface uniformity in device properties to be manufactured can be improved.

### [Spectrometric Optical System]

Hereinafter, a spectrometric optical system will be described.

An Offner type optical system and an Offner type spectrometry apparatus using the same will be described.

### Offner Type Optical System According to Reference Embodiment

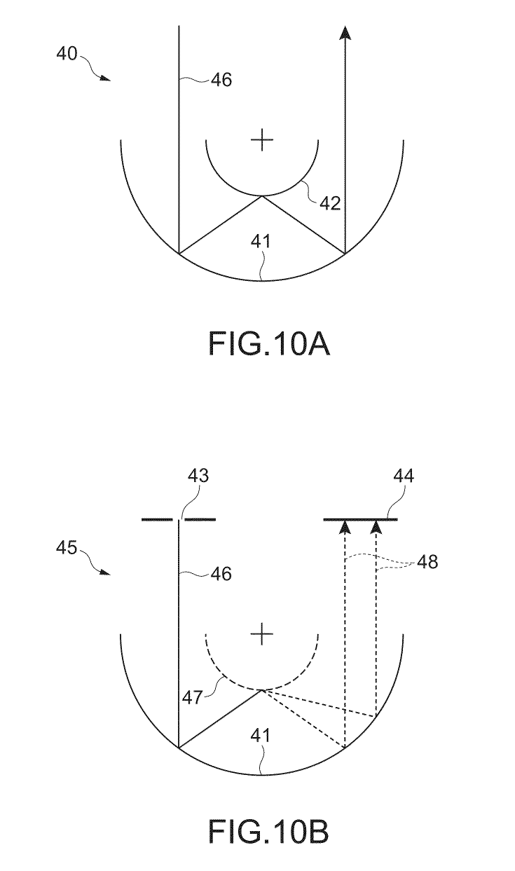

FIG. 10A shows a principle of an Offner type same magnification optical system (a relay optical system). The Offner type optical system 40 includes a primary mirror 41 disposed along a first circle (a part thereof), and a secondary mirror 42 disposed along a second circle (a part thereof). The primary mirror 41 is a concave mirror, and the secondary mirror 42 is a convex mirror.

A light 46 is input on the Offner type optical system 40, is incident on the primary mirror 41, is reflected by the primary mirror 41, reflected by the secondary mirror 42, again reflected by the primary mirror 41, and is output from the Offner type optical system 40. The Offner type relay optical system has the properties such as very little optical aberration and distortion.

### (Offner Type Spectrometry Apparatus According to Reference Embodiment)

FIG. 10B shows a principle of an Offner type spectrometer 45 utilizing the above-mentioned Offner type optical system 40.

The Offner type spectrometer 45 uses a diffraction grating 47 instead of the secondary mirror 42 of the optical system shown in FIG. 10A. Namely, a total shape of a surface on which a light is incident in the diffraction grating 47 is a convex shape along the second circle. The light is input via a slit 43, is reflected by the primary mirror 41 and is incident on the diffraction grating 47. A diffracted light 48 having a specific wavelength range emitted from the diffraction grating 47 is reflected again by the primary mirror 41, and is incident on an image sensor 44 disposed at a predetermined position. The image sensor 44 detects the diffracted light 48.

As described above, the spectrometer 45 including the Offner type optical system is called as an imaging spectrometer, and can inhibit the distortion of slit images. Also, as described above, the technology relating to the Offner type spectrometer is disclosed in the above-mentioned Japanese Patent Application Laid-open No. 2008-510964, for example.

### Spectrometric Optical System According to First Embodiment

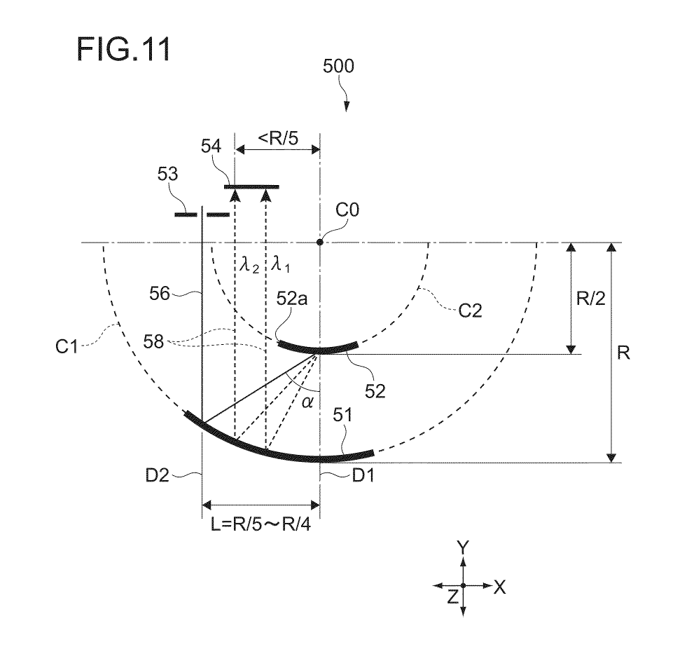

FIG. 11 shows a spectrometric optical system according to the first embodiment of the present technology.

A spectrometric optical system 500 utilizes the above-mentioned Offner type optical system. The spectrometric optical system 500 includes a slit element 53, a reflection member 51 (corresponds to the primary mirror), and a diffraction grating 52.

The slit element 53 has a slit and functions as an input element either in whole or in part. The slit element 53 narrows a diameter of an input light (here a laser beam) input from outside to the spectrometric optical system 500 with a slit, and leads the input beam 56 to the concave surface of the reflection member 51. Although not shown, a slit shape viewing from the light axis direction is typically a circle. The slit shape may be otherwise a polygonal shape, an oval shape, a line shape and the like.

The slit element 53 has a slit for providing a beam with NA (Numerical Aperture) of about 0.1 or less that shows a divergence angle of the input beam 56.

The reflection member 51 has a concave surface disposed along a virtual first circle C1. The input beam from the slit element 53 is reflected by the concave surface to the diffraction grating 52.

The diffraction grating 52 is disposed along a virtual second circle C2 as a concave shape. Namely, a total shape of a surface on which a light is incident in the diffraction grating 52 is a convex shape.

The first circle C1 and the second circle C2 are in a concentric relation to each other. Each radius of curvature on the convex surface of the reflection member 51 and the incident surface of the diffraction grating 52 is set such that the radius of curvature on the first circle C1 is R and the radius of curvature on the second circle C2 is substantially R/2. The value R/2 is set to realize the Offer type spectrometric optical system 500. As long as the value is attained, an error range ((R/2)±5%), i.e., R/2±(R/2×0.05), may be included.

The diffraction grating 52 is positioned such that an intersection point between an axis (first axis) D1 (along an Y axis) perpendicular to a center axis C0 that is a common axis of the first circle C1 and the second circle C2 (in FIG. 11, an axis along a Z axis) and the diffraction grating 52 becomes a principal point of the diffraction grating 52. The input beam 56 reflected by the concave surface of the reflection member 51 is incident on the diffraction grating 52 at an incident angle α so as to intersect with the principal point. Hereinafter, the first axis D1 is referred to as a center perpendicular axis D1 as a matter of description convenience.

The light axis of the input beam 56 emitted through the slit element 53 will be parallel with the center perpendicular angle axis D1. A distance L between the perpendicular angle axis D1 and a (second) axis D2 that coincides with the light axis of the input beam 56 incident on the reflection member 51 is set as R/5<L<R/4.

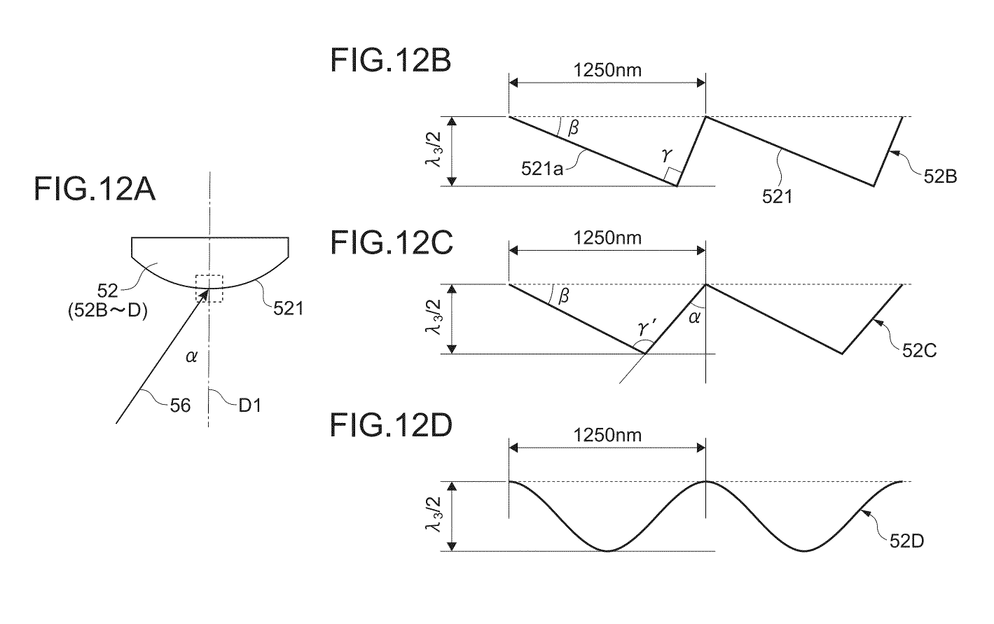

FIGS. 12B to 12D each shows an enlarged view of a square enclosed by a dashed line of the incident surface 521 of the diffraction grating 52 shown in FIG. 12A.

The diffraction grating 52B shown in FIG. 12B is a brazed diffraction grating 52. A brazed angle β is about 19 to 23 degrees. A brazed apex angle λ is 90 degrees. In this case, the positions of the input beam and the diffraction grating 52 are set such that a long side 521a of the incident surface 521 in the diffraction grating 52B is perpendicular to the input beam, i.e., the incident angle becomes 0 degree. Thus, the diffraction efficiency is maximized.

The diffraction grating 52C shown in FIG. 12C is also the brazed diffraction grating as described above. The diffraction grating 52C is different from the diffraction grating 52B shown in FIG. 12B at the point that the brazed apex angle λ′ exceeds 90 degrees. In this embodiment, the incident angle of the input beam is α(=180−β−λ′). Namely, the incident angle is not 0 degree as described above.

The diffraction grating 52D shown in FIG. 12D is a diffraction grating 52 having an incident surface with a sine wave shape, which is called as a holographic shape. The diffraction efficiency is lower than those of the diffraction gratings shown in FIGS. 12B and 12C.

Each pitch of the diffraction gratings 52B to 52D shown in FIGS. 12B to 12D is typically 1250 nm, but is not limited thereto. The pitch is changed depending on the wavelength region of the diffracted light to be detected.

A depth of each of these diffraction gratings 52B to 52D is defined by λ₃/2 where λ₃ is a central wavelength of the wavelength region to be detected.

The number of the grooves per 1 mm in each of these diffraction gratings 52B to 52D is 300 to 1000, 400 to 900 or 500 to 800.

The diffracted light 58 having the wavelength region of not less than λ₁ and not more than λ₂ (see FIG. 11) is emitted from the diffraction gratings 52 configured as described above, is reflected at the concave surface of the reflection member 51, and passes between the input beam 56 emitted through the slit element 53 and an edge part 52a of the diffraction grating 52. Namely, the diffracted light having the above-mentioned wavelength region is emitted at an incident beam side not at a center perpendicular axis D1 side, and each emitted angle of the diffraction gratings 52 is smaller than the incident angle α. As described above, because the NA is about 0.1 or less, the input beam 56 and the diffracted light 58 will not be crossed along the Y axis direction. The diffracted light 58 having a short wavelength λ₁ proceeds to near the center perpendicular axis D1, and the diffracted light 58 having a long wavelength λ₂ proceeds to near the light axis of the input beam 56.

The fact is true on an X-Y plane in FIG. 11. Specifically, the light axis of the input beam 56 incident on the concave surface, the light axis of the diffracted light having the wavelength λ₁, the light axis of the diffracted light having the wavelength λ₂, and the center perpendicular axis D1 are substantially on the same X-Y plane.

The NA is desirably 0.03 or more.

The distance between the center perpendicular axis D1 and the light axis of the diffracted light having the wavelength λ₂ is set to become shorter than R/5.

For example, λ₁ is 600 nm, and λ₂ is 1100 nm. Alternatively, λ₁ is 700 nm, and λ₂ is 1000 nm.

In this way, the diffracted light 58 passes between the input beam 56 and the edge part 52a of the diffraction grating 52, exits from the spectrometric optical system 500, and is detected by the image sensor 54 disposed at a predetermined position. The image sensor 54 may be a CCD (Charge Coupled Device), a CMOS (Complementary Metal-Oxide Semiconductor) or the like, for example.

Thus, the Offner type spectrometric optical system 500 according to the embodiment can detect the diffracted light 58 having the wavelength region of not less than 600 nm to not more than 1100 nm, the diffracted light passing between the input beam 56 and the edge part 52a of the diffraction grating 52.

Since the spectrometric optical system 500 is the Offner type, an optical aberration is small, and a distortion of an input beam image input through the slit element 53 can be inhibited.

The embodiment can provide an imaging spectrometer and a Raman imaging apparatus having a broad image area.

In the spectrometric optical system 500 according to the first embodiment, the NA is mainly 0.1 or less. The limitation of the NA is based on the premise that the spectrometric optical system 500 is connected to a microscope optical system as described layer. In many cases, the NA in an entrance of an objective lens in the microscope optical system is set to a significantly high value in order to enhance a resolution. For example, when the objective lens has magnifying power of 60 times, the NA is normally about 0.7.

Instead, the NA is as significantly low as about 0.012 (0.7/60=0.012) at an outlet side of the spectrometric optical system 500 to which the image sensor 54 is attached. Although the magnitude of the NA may be considered as an index of luminance of the spectrometric optical system 500, the high NA is unnecessary when the slit element 53 is directly installed on the image surface of a port for attaching a camera of the spectrometric optical system 500. It is sufficient that the NA may be about 1.1. The luminance of the spectrometric optical system 500 is mainly determined by the NA of the objective lens in the microscope optical system 500.

### Spectrometric Optical System According to Second Embodiment

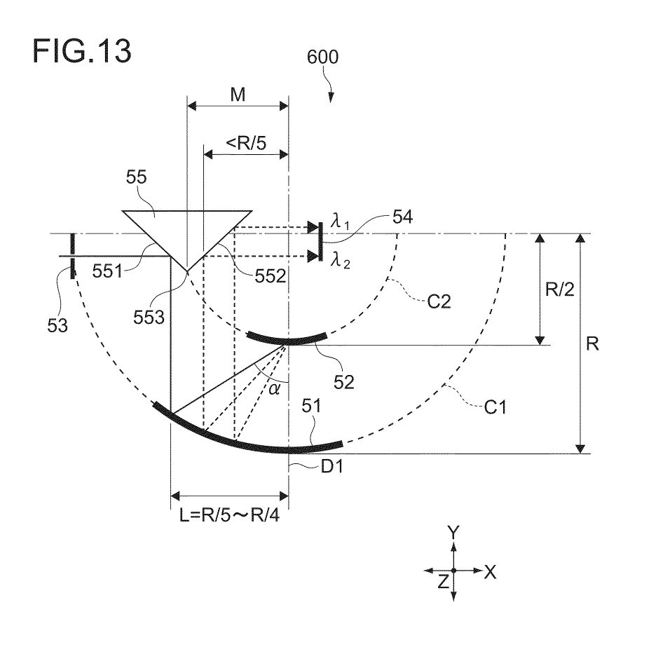

FIG. 13 shows a spectrometric optical system 600 according to the second embodiment of the present technology. Hereinafter, the members, the functions and the like similar to those of the spectrometric optical system 500 according to the embodiment shown in FIG. 11 and the like are simplified or omitted, and different points will be mainly described.

The spectrometric optical system 600 includes the slit element 53 and a prism mirror 55. The prism mirror 55 has a first mirror surface 551 and a second mirror surface 552 that is at right angle thereto. Namely, it is a right angle prism mirror. The first mirror surface 551 and the second mirror surface 552 are disposed at an angle of 45 degrees in an X axis direction.

The image sensor 54 is disposed, for example, near the center of the first and second circles (C1 and C2), and detects the diffracted light emitted from the second mirror surface 552.

The input beam is incident at an angle of 45 degrees on the first mirror surface 551, i.e., along the X axis direction and is reflected at a reflection angle of 45 degrees on the first mirror surface 551. Then, the input beam is guided to the concave surface of the reflection member 51 along the Y axis direction. The diffracted light, that is diffracted on the diffraction grating 52 and reflected on the concave surface, is incident on the second mirror surface 552 at an incident angle of 45 degrees along the Y axis direction. Then, the incident light is reflected at a reflection angle of 45 degrees on the second mirror surface 552, and is guided to the image sensor 54 along the Y axis direction.

A distance M between an apex 553 that is a crossing part of the first mirror surface 551 and the second mirror surface 552 and the center perpendicular axis D1 is typically set such that the light axis of λ₂ which is the longest wavelength to be detected in the Y axis direction and the light angle of the input beam in the Y axis direction become symmetric about the line along the Y axis direction.

According to the embodiment, the prism mirror 55 allows the input beam to be incident along the direction at a right angle (the X axis direction) to the center perpendicular axis D1, and also allows the diffracted light to be emitted along the X axis direction. Thus, the slit element 53 and the image sensor 54 are linearly disposed across the prism mirror 55, thereby decreasing an installation space of the slit element 53, the prism mirror 55 and the image sensor 54. As a result, the image sensor 54 can be freely disposed. Also, the space-saving may reduce the size of the spectrometric optical system 600.

In the spectrometric optical system 500 according to the first embodiment, a distance between the input light and the output light, i.e., the diffracted light becomes near. Therefore, the slit element 53 and the image sensor 54 (camera) may not be disposed along the X axis direction depending on their physical sizes, and may not be laid out simply. However, according to the spectrometric optical system 600 of the second embodiment, the slit element 53 and the image sensor 54 are linearly disposed, making the mechanical layout simple.

The spectrometric optical system 600 may include a band pass filter for passing the input light having the wavelength region of 600 nm to 1100 nm before the slit element 53. The band pass filter can avoid the situation that the light having the wavelength outside the wavelength to be detected returns to the slit element 53 by the prism mirror 55. The generation of a stray light within the spectrometric optical system 600 can be avoided.

However, the band pass filter is unnecessary so long as the spectrometric optical system 600 is designed to exclude the light having the wavelength outside the wavelength region of 600 nm to 1100 nm.

### (Embodiment of Spectrometric Optical System)

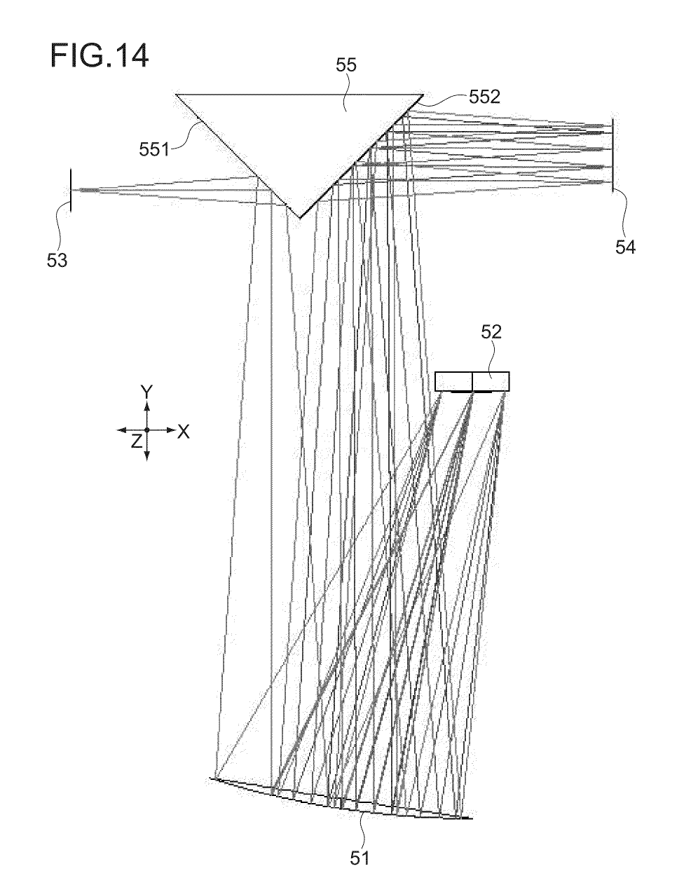

FIG. 14 shows an example of the spectrometric optical system 600 according to the second embodiment. The design specification is as follows:

Wavelength region to be detected: 785 to 940 nm

Image range: 14 mm (the image area is 0.07 R where R is the radius of curvature of the concave surface in the reflection member 51)

NA: 0.08

Wavelength resolution: 0.6 nm (0.15 nm by sampling of the image sensor 54)

Radius of curvature R of the concave surface: 200 mm

Radius of curvature (R/2) of incident surface of diffraction grating 52±5%:103 mm

Number of ruling lines in the diffraction grating 52: 800/mm

Incident light beam shift L: R/5 to R/4 (L=46 mm)

Incident angle α to diffraction grating 52: 26.6 degrees

The above-described specification parameters are illustrative for the spectrometric optical system 600. By optimizing the distance between the concave surface and the incident surface of the diffraction grating 52 as well as the radius of curvature thereof, the resolution in the diffraction limit when NA=0.08 can be realized. Also, such a design can significantly decrease the distortion, i.e., an optical strain.

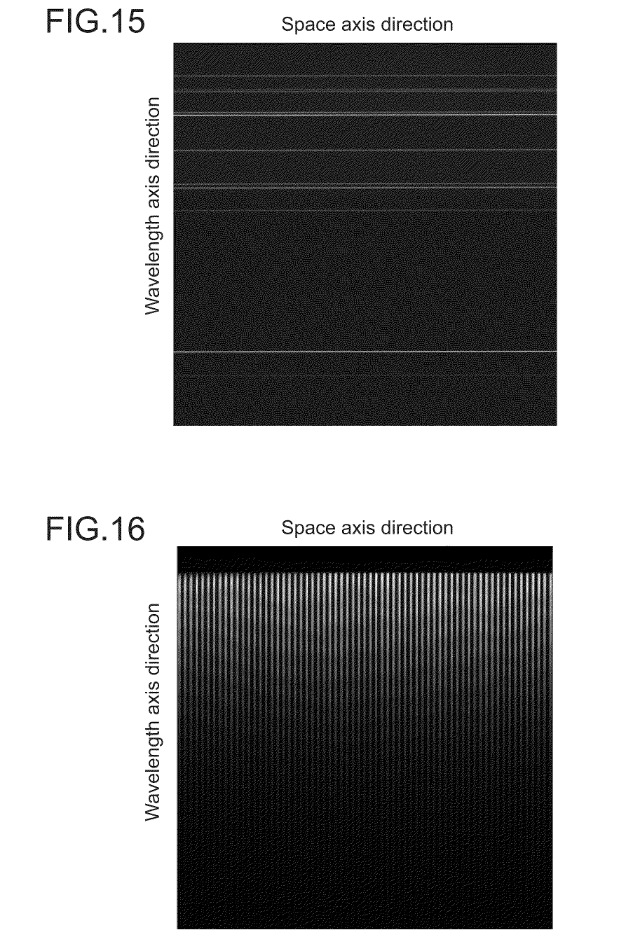

FIG. 15 shows a data upon observation of illumination of an Ar lamp of the spectrometric optical system according to the embodiment. The space axis direction is the longitudinal axis direction in the embodiment. The wavelength resolution satisfies the specification. Apparently, the distortion is significantly low.

FIG. 16 shows an observed example of a line and space at a 10 μm pitch by connecting the spectrometric optical system to the microscopic optical system according to the embodiment. The view confirms that it provides a high resolution not only at the center but also at outside.

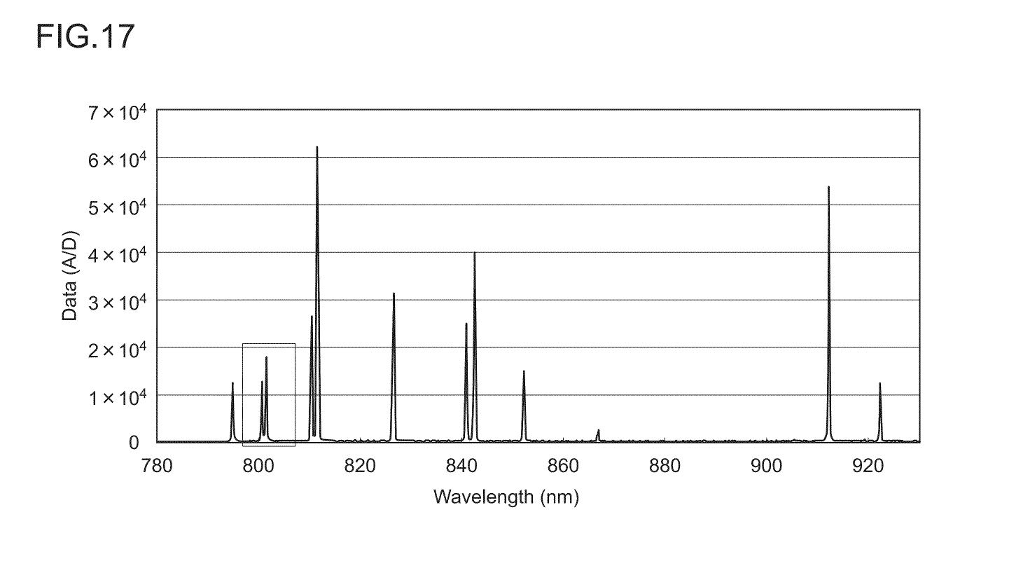

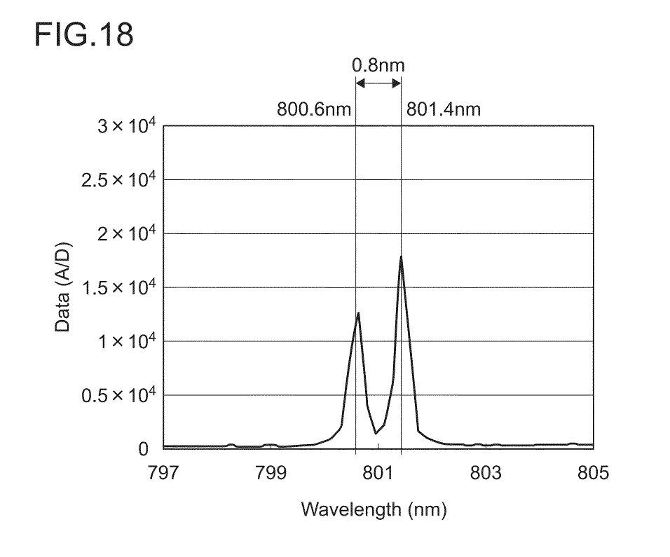

FIG. 17 is a graph of a spectrum of an Ar lamp measured by using the spectrometric optical system according to the embodiment. The graph (in particular, see an enlarged view at a wavelength of around 800 nm shown in FIG. 18) reveals that the wavelength resolution is 0.6 nm or less.

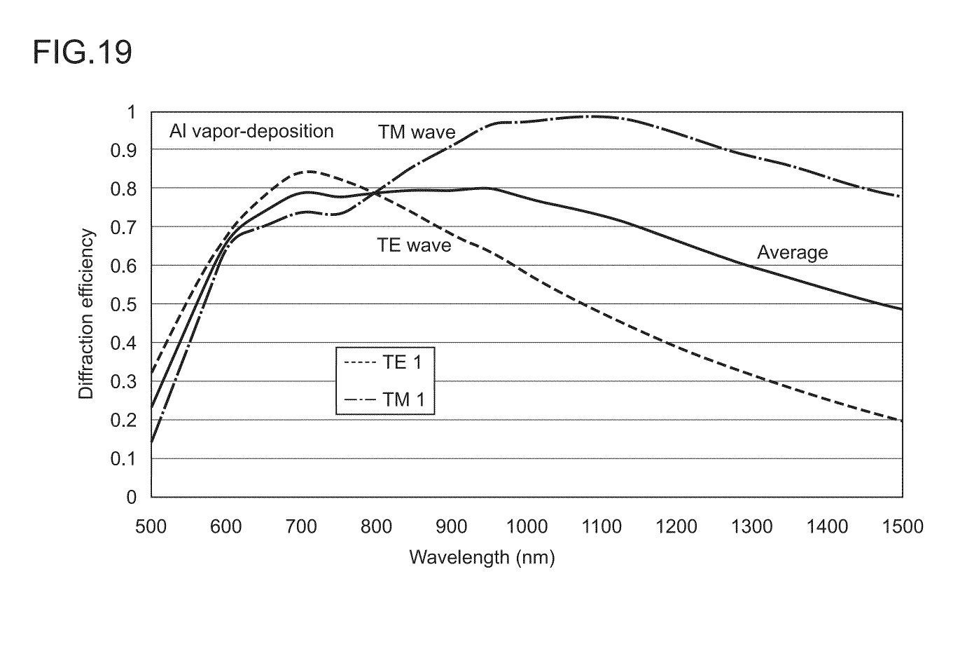

FIG. 19 shows a calculation example of a diffraction efficiency of the diffraction grating 52C shown in FIG. 12C using an RCWA (Rigorous Coupled Wave Analysis) method. In this case, A1 is vapor deposited on the incident surface of the diffraction grating 52C. A TE wave is a light beam having a polarized wave surface in a direction parallel to the ruling line of the diffraction grating 52C. A TM wave is a light beam having a polarized wave surface in a direction perpendicular to the ruling line of the diffraction grating 52C.

### [Spectrometer]

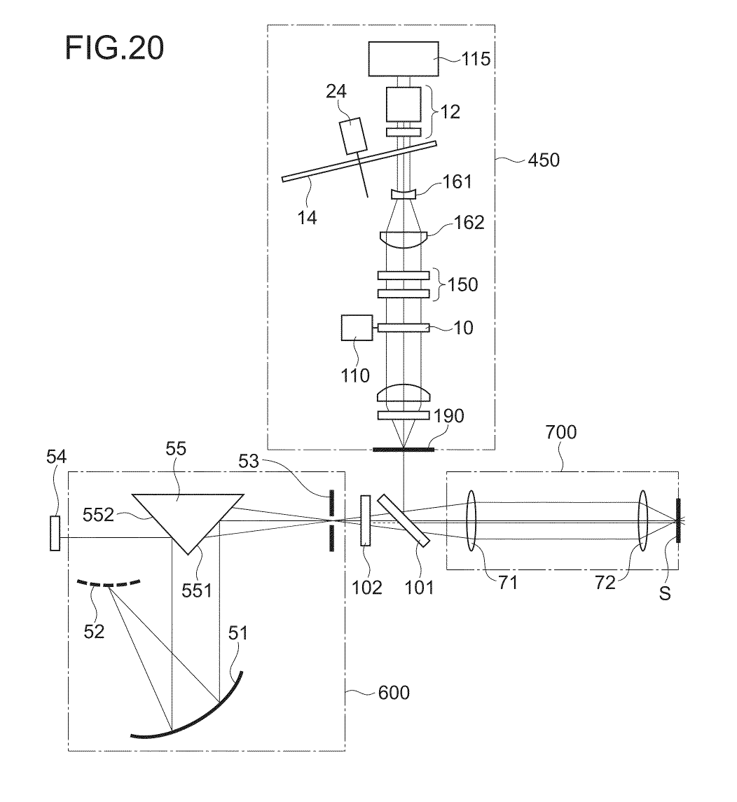

As the spectrometer including the illumination optical system and the spectrometric optical system 600 according to the embodiment as described above, an embodiment of a Raman imaging apparatus will be shown. FIG. 20 shows a configuration of an optical system in the Raman imaging apparatus.

The Raman imaging apparatus mainly includes an illumination optical system 450, a microscopic optical system 700 and the spectrometric optical system 600 shown in FIG. 13.

In the illumination optical system 450, the integrator lens 15 of the illumination optical system 400 shown in FIG. 6 is replaced with the above-described dyad integrator elements 150.

An LD package 115 including the laser diode 11 (see FIG. 6) incorporates a wavelength locking element for stabilizing the wavelength of the laser and reducing a line width. The Raman imaging apparatus has a long axis of 14 mm to be detected, and irradiates the 14 mm region with an irradiated light in the longitudinal direction. The integrator elements 150 and the oscillation mirror (resonant mirror) 10 produce an illuminated light of 14 mm×0.085 mm.

The ND filter 14 disposed at the illumination optical system 450 is a disk-shaped ND filter that can be rotated by a stepping motor 24, for example. A driver 110 is connected to the oscillating element 10.

The laser beam output from the illumination optical system 450 is input to a microscopic optical system 700 via a dichroic beam splitter 101. The dichroic beam splitter 101 reflects the laser beam having the specific wavelength region, and transmits the laser beam having the wavelength of 795 nm or more output and Raman-shifted from the microscopic optical system 700, for example.

The microscopic optical system 700 includes a microscopic collecting lens 71 and an objective lens 72. A sample S is positioned facing to the objective lens 72.

An image surface 190 that is explained above as the screen 19 and the slit element 53 (including the input surface thereof) of the spectrometric optical system 600 are disposed on an optical conjugation surface via the dichroic beam splitter 101. An image is formed on the conjugation surface that is reduced at the same magnification and overlapped with the microscopic collecting lens 71 and the objective lens 72. In other words, according to the embodiment, the dichroic beam splitter 101 and the microscopic optical system 700 form the optical system where the conjugation relation described above is kept.

The laser beam transmitted through the dichroic beam splitter 101 is input to the spectrometric optical system 600 via a Raman excitation light cut filter 102. The Raman excitation light cut filter 102 is a highpass filter that is disposed such that the light within the specific wavelength region of the Raman scattering light is not incident to the spectrometric optical system 600.

As described above, the production of an optical aberration, a distortion, interference fringes and speckles can be inhibited by the Raman imaging apparatus according to the embodiment. In addition, the camera including the image sensor can be freely disposed, thereby reducing the size of the Raman imaging apparatus.

### Other Embodiments

The present technology is not limited to the above-described embodiments, and other various embodiments may be made.

Although the resonant mirror driven by the electromagnetic action is used as the oscillating element 10, an electrostatic action, piezoelectric action and the like may be utilized for driving. In these cases, a driving unit of the oscillating element 10 may be manufactured by MEMS (Micro Electro Mechanical Systems).

The oscillating element 10 may not be driven by a resonance or a vibration, i.e., with no amplitude, at a maximum seed, and may be driven, for example, at a substantially constant speed.

Alternatively, the oscillating element 10 may not be the vibrating mirror, but may be an acoustooptic element. The acoustooptic element includes an acoustooptic crystal, a driving electrode disposed on the acoustooptic crystal and the like. The acoustooptic element can control variably a lattice constant of the crystal and a refraction index of a light passing through the crystal by applying a voltage to the acoustooptic crystal via the driving electrode. Thus, the light emitted from the acoustooptic element can be oscillated.

The above-mentioned illumination optical system 100 includes the integrator lens 15 having power only in the long axis direction or both in the long and short axes directions. However, the illumination optical system 100 may include the integrator lens 15 having power, for example, only in the short axis direction. Any axis direction and focal length can be selected so that the illumination light has finally the desirable aspect ratio.

The illumination optical system 100 according to the fourth embodiment may include no isolator 12.

For example, the single collecting lens 17 is used as the collecting element, as shown in FIG. 2. However, the collecting element may include a plurality of the collecting lenses 17.

The illumination optical system 600 shown in FIG. 13 includes the prism mirror 55, and the prism mirror 55 includes the first mirror surface 551 and the second mirror surface 552. However, the system 600 may not include the prism, but may include at least two mirrors (a first mirror and a second mirror). These two mirrors may be arranged along the X axis direction, or may be not aligned and one of them may be arranged along the Y axis direction.

Alternatively, either one of the first mirror and the second mirror may be disposed. In this case, the light output through the slit element 53 and the light input to the sensor are at angle of 90 degrees. The configurations can provide the optical properties similar to the illumination optical systems 500 and 600.

In the Raman imaging apparatus according to the above-mentioned embodiment, the microscopic optical system 700 and the dichroic beam splitter 101 are used as the optical system to keep the conjugation relation between the image surface 190 and the slit element 53. However, it is not limited to the microscopic optical system 700, and the relay optical system with the same magnification may provide the optical system where the conjugation relation is kept.

As a sensor used in the spectrometric optical system and the spectrometer including the same according to the above-mentioned respective embodiments, an image sensor is cited as an example. Also, the sensor may be a photodiode.

At least two of the features as described above in the respective embodiments may be combined.

The present technology may have the following configurations.

[1] A spectrometric optical system, including:

a reflection member having a concave surface formed along a first circle,

a diffraction grating having an edge part and a convex surface formed along a second circle disposed concentrically with the first circle, on which the light reflected at the concave surface of the reflection member is incident, and

an input element disposed at a predetermined position to the reflection member and the diffraction grating such that a diffracted light, emitted from the diffraction grating, having a wavelength region of not less than 600 nm to not more than 1100 nm, and reflected at the concave surface, passes between the input light input to the spectrometric optical system and the edge part of the diffraction grating.

[2] The spectrometric optical system according to [1] above, in which

the diffraction grating has a principal point that is intersected with a first axis perpendicular to a center axis that is a common axis of the first circle and the second circle.

[3] The spectrometric optical system according to [2] above, in which

the diffraction grating emits a diffracted light at an emission angle smaller than an incident angle of the light reflected on the concave surface to the diffraction grating.

[4] The spectrometric optical system according to [2] above, in which

each radius of curvature on the convex surface of the reflection member and the concave surface of the diffraction grating is set, such that the radius of curvature on the second circle is R and the radius of curvature on the first circle is substantially (R/2)±5%).

[5] The spectrometric optical system according to [4] above, in which

a distance between the first axis and the second axis that is in parallel with the first axis and coincides with the light axis of the input light incident on the concave surface may be R/5 to R/4.

[6] The spectrometric optical system according to any one of [2] to [5] above, in which

the input element has a slit element having a slit for passing the input light.

[7] The spectrometric optical system according to [6] above, in which

the input element has at least one of a first mirror for reflecting the input light emitted from the slit element and leading it to the concave surface, and a second mirror for reflecting the diffracted light reflected on the concave surface and leading it to the sensor.

[8] The spectrometric optical system according to [7] above, in which

the input element has a prism mirror including the first mirror and the second mirror.

[9] The spectrometric optical system according to [7] or [8] above, in which

the slit element and the prism are disposed such that an incident angle of the input light to the first mirror is 45 degrees and an incident angle of the diffracted light to the second mirror is 45 degrees.

[10] The spectrometric optical system according to any one of [6] to [9] above, in which

the slit element has an NA (Numerical Aperture) of 0.1 or less.

[11] The spectrometric optical system according to any one of [1] to [10] above, further including:

a band pass filter disposed before the input element for passing the input light having the wavelength region of 600 nm to 1100 nm.

[12] A spectrometer, including:

an illumination optical system, having:
a laser light source,
an integrator element,
an oscillating element being capable of guiding the laser beam emitted from the laser light source to the integrator element, and oscillating to change an incident angle of the laser beam to the integrator element, and
a light collecting element for collecting the laser beam emitted from the oscillating element,

a spectrometric optical system, having:
a reflection member having a concave surface formed along a first circle,
a diffraction grating having an edge part and a convex surface formed along a second circle disposed concentrically with the first circle, on which the light reflected at the concave surface of the reflection member is incident, and
an input element disposed at a predetermined position to the reflection member and the diffraction grating such that a diffracted light, emitted from the diffraction grating, having a wavelength region of not less than 600 nm to not more than 1100 nm, and reflected at the concave surface, passes between the input light input to the spectrometric optical system and the edge part of the diffraction grating, and

an optical system that maintains an optical conjugation between a collecting surface of the laser beam emitted from the collecting element and an input surface of the laser beam incident on the input element optically conjugated.

The present technology contains subject matter related to that disclosed in Japanese Priority Patent Application JP 2012-047370 filed in the Japan Patent Office on Mar. 2, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A spectrometric optical system, comprising:
a reflection member having a concave surface formed along a first circle;
a diffraction grating having an edge part and a convex surface formed along a second circle disposed concentrically with the first circle, on which the light reflected at the concave surface of the reflection member is incident; and
an input element disposed at a predetermined position to the reflection member and the diffraction grating such that a diffracted light, emitted from the diffraction grating, having a wavelength region of not less than 600 nm to not more than 1100 nm, and reflected at the concave surface, passes between the input light input to the spectrometric optical system and the edge part of the diffraction grating.

2. The spectrometric optical system according to claim 1, wherein
the diffraction grating has a principal point that is intersected with a first axis perpendicular to a center axis that is a common axis of the first circle and the second circle.

3. The spectrometric optical system according to claim 2, wherein
the diffraction grating emits a diffracted light at an emission angle smaller than an incident angle of the light reflected on the concave surface to the diffraction grating.

4. The spectrometric optical system according to claim 2, wherein
each radius of curvature on the convex surface of the reflection member and the concave surface of the diffraction grating is set, such that the radius of curvature on the second circle is R and the radius of curvature on the first circle is substantially (R/2)±5%).

5. The spectrometric optical system according to claim 4, wherein
a distance between the first axis and the second axis that is in parallel with the first axis and coincides with the light axis of the input light incident on the concave surface may be R/5 to R/4.

6. The spectrometric optical system according to claim 2, wherein
the input element has a slit element having a slit for passing the input light.

7. The spectrometric optical system according to claim 6, wherein
the input element has at least one of a first mirror for reflecting the input light emitted from the slit element and leading it to the concave surface, and a second mirror for reflecting the diffracted light reflected on the concave surface and leading it to the sensor.

8. The spectrometric optical system according to claim 7, wherein
the input element has a prism mirror including the first mirror and the second mirror.

9. The spectrometric optical system according to claim 7, wherein
the slit element and the prism are disposed such that an incident angle of the input light to the first mirror is 45 degrees and an incident angle of the diffracted light to the second mirror is 45 degrees.

10. The spectrometric optical system according to claim 6, wherein
the slit element has an NA (Numerical Aperture) of 0.1 or less.

11. The spectrometric optical system according to claim 1, further comprising:
a band pass filter disposed before the input element for passing the input light having the wavelength region of 600 nm to 1100 nm.

12. A spectrometer, comprising:
an illumination optical system; having
a laser light source,
an integrator element,
an oscillating element being capable of guiding the laser beam emitted from the laser light source to the integrator element, and oscillating to change an incident angle of the laser beam to the integrator element, and
a light collecting element for collecting the laser beam emitted from the oscillating element,
a spectrometric optical system; having
a reflection member having a concave surface formed along a first circle having a center,
a diffraction grating having an edge part and a convex surface formed along a second circle disposed concentrically with the first circle, on which the light reflected at the concave surface of the reflection member is incident, and
an input element disposed at a predetermined position to the reflection member and the diffraction grating such that a diffracted light, emitted from the diffraction grating, having a wavelength region of not less than 600 nm to not more than 1100 nm, and reflected at the concave surface, passes between the input light input to the spectrometric optical system and the edge part of the diffraction grating; and
an optical system that maintains an optical conjugation between a collecting surface of the laser beam emitted from the collecting element and an input surface of the laser beam incident on the input element optically conjugated.
